(19) United States
(12) Patent Application Publication
(10) Pub. No.: US 2004/0201736 A1
(43) Pub. Date: Oct. 14, 2004

(54) Digital image identification system

(76) Inventor: Robert J. Squiers JR., Grosse Pointe Shores, MI (US)

Correspondence Address: ARTZ & ARTZ, P.C., 28333 TELEGRAPH RD., SUITE 250, SOUTHFIELD, MI, 48034, US

(21) Appl. No.: 09/930,697

(22) Filed: Aug. 15, 2001

(51) Int. Cl. H04N 5/76; H04N 5/262; H04N 7/00

(52) U.S. Cl. 348/231.2; 348/239; 348/552

(57) ABSTRACT

A system for cataloging a digital image created by a digital camera includes a character string. The system further includes a character input device subject to receive the character string. A memory file, which stores the digital image in the digital camera, is identified by the character string.

The present invention relates generally to photography, and more particularly to photographic image identification.

### BACKGROUND

It is well known in the camera industry that businesses often use photography to catalogue merchandise and to verify its condition both before and after transportation. As volumes of images increase, cataloging becomes labor intensive.

Prior to digital imaging, Polaroid™ style photographs were the optimal medium for recording defects in products. They developed instantly and could be attached to the product paperwork. The product paperwork was then filed, stored and retrieved when necessary. In large volumes, this process tended to become cumbersome.

Digital imaging shares many of the advantages of Polaroid™ photography. It further offers, however, increased versatility because, for example, it allows copies to be made almost instantly, and it facilitates image postings on the world wide web.

Digital cameras currently have functions to display the date or image number on an image. The image number, however, starts at one and advances with each successive image until camera storage is exhausted. These displays generally do not provide businesses with sufficient categorization parameters necessary for an efficient cataloging system.

Another negative aspect of digital cameras is that once a series of digital images has been taken and stored in computer files, the images must then be named and downloaded and placed in their appropriate files. For large volumes of images, this tends to become a laborious process.

The disadvantages associated with these conventional digital image identification techniques have made it apparent that a new technique for digital image identification is needed. The new technique should have a user interface and should also have a precise system for identifying multiple sets of images. The present invention is directed to these ends.

### SUMMARY OF THE INVENTION

It is an object of the present invention to provide an improved identification system. It is also an object of the present invention to provide an improved digital image identification system.

In accordance with the present invention, a system for cataloging a digital image created by a digital camera is disclosed. The system includes a character string. The system further includes a character input device subject to receive the character string. A memory file on the digital camera is subject to identification by the character string. The memory file is further subject to electronically store the digital image.

Additional advantages and features of the present invention will become apparent from the description that follows and may be realized by the instrumentalities and combinations particularly pointed out in the appended claims, taken in conjunction with the accompanying drawings.

### BRIEF DESCRIPTION OF THE DRAWINGS

For a more complete understanding of the invention, there will now be described some embodiments thereof, given by way of example, reference being made to the accompanying drawings, in which:

FIG. 1 is a perspective view of a digital image identification system in accordance with one embodiment of the present invention;

FIG. 2 is a perspective view of a digital image identification system in accordance with another embodiment of the present invention;

FIG. 3 is a perspective view of a digital image identification system in accordance with another embodiment of the present invention; and

FIG. 4 is a logic flow diagram of a digital image identification system in accordance with one embodiment of the present invention.

### DETAILED DESCRIPTION

The present invention is illustrated with respect to a digital image identification system 10, particularly suited to maintain product quality records. However, the present invention is applicable to various other uses that may require digital image identification systems, as will be understood by one skilled in the art.

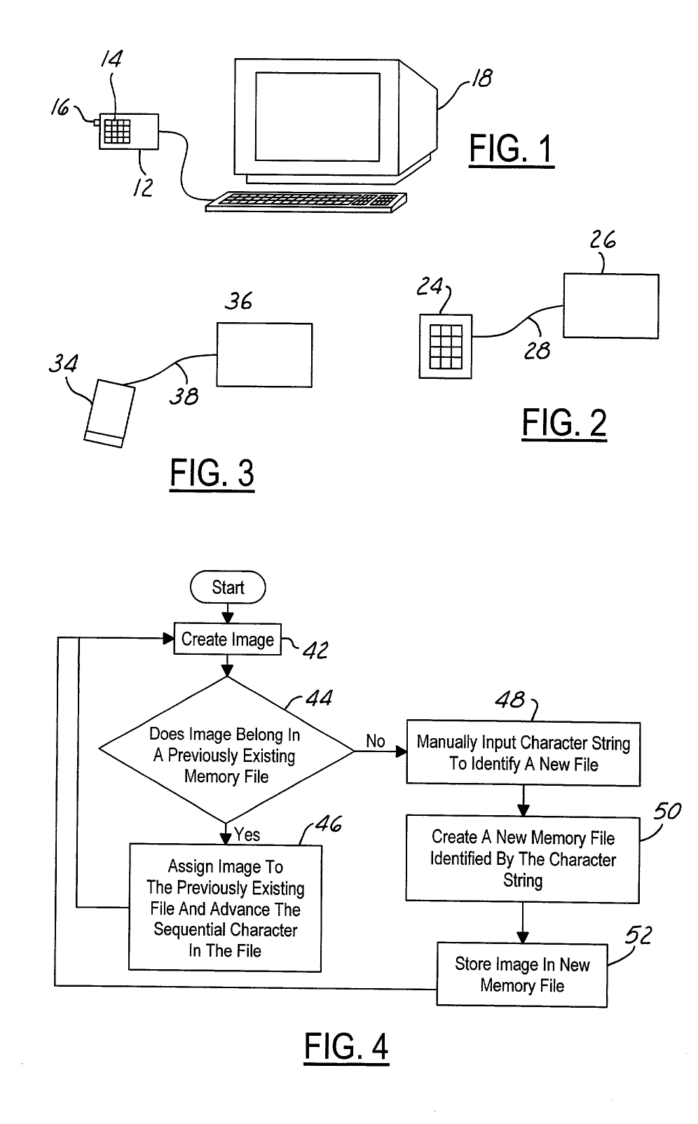

Referring to FIG. 1, a digital image identification system 10, in accordance with one embodiment of the present invention, is illustrated. The identification system 10 includes a digital camera 12 and a digital camera operator. The identification system 10 further includes a character string, which is input by a digital camera operator into a character input device 14. The preferred steps to input the character string will be discussed later.

The character string is embodied as a series of letters corresponding to a subset of images dealing with a specific product. The character string is further embodied with a series of numbers corresponding to a set of subsets dealing with a product line. To illustrate, character string 001A has the following features: the “A” portion of the character string references a digital image of an individual product. The subsequent digital image of that product is 001B. The “001” portion references a set of individual products. The first product is identified as “001.” The second product is identified as “002.”

For the current embodiment the letter portion of the character string sequences automatically when a series of images are taken. The numeric portion is sequenced by the digital camera operator engaging the switch 16 or typing in the subsequent numerical value on the character input device 14.

The switch 16, here embodied as a button, supplements the operation of the character input device 14. The switch 16 facilitates rapid creation of multiple sets of images. To illustrate, when a sufficient quantity of digital images are taken of a product, the camera operator engages the switch 16. This indexes the letter portion of the character string to signify and identify a second product.

A memory file on the digital camera 12 is subject to identification by the character string. The memory file electronically stores the digital image. The memory file may further store numerous other digital images as required by the digital camera operator. The identification and storage of the digital image will be discussed later.

In the present embodiment, the character input device 14 is a keypad attached directly to the digital camera 12. Numerous other designs for the character input device 14 and the connection to the digital camera 12 will be discussed later.

Following the storage of the digital image, the digital image is downloaded to a remote server 18, which is illustrated as a personal computer.

FIGS. 2 and 3 illustrate alternate embodiments of the present invention. For example, FIG. 2 the character input device 24 is independent of the digital camera 26. In other words, a data transfer link 28, in the form of a wire, cable or other data transfer apparatus, connects the character input device 24 to the digital camera 26, as will be understood by one skilled in the art. FIG. 3 illustrates the character input device 34 as a bar code reader connected to the digital camera 36 by a data transfer link 38. This simplifies the input of a character string by a digital camera operator when cataloging inventory labeled with bar codes because the bar codes identify the product with a character string that is easily scanned into the character input device 34.

Referring to FIG. 4 in view of FIG. 1, a logic flow diagram of the operation of a digital image identification system controller, in accordance with one embodiment of the present invention, is illustrated. The controller is responsive to an image created with the digital camera. The logic starts in operation block 42 by creating the digital image. After the start of the logic flow diagram shown in FIG. 2, a check is made in inquiry block 44 as to whether the new digital image belongs in a previously existing memory file as another image. For a positive answer, the new digital image is assigned to the previously existing memory file as shown in operation block 46. The new digital image is then assigned a subsequent character value to previously assigned digital images in the previously existing memory file.

Otherwise, operation block 48 becomes active and the digital camera operator manually inputs a new character string to identify a new memory file.

In operation block 50, the digital camera creates a new memory file identified by the new character string inputted in operation block 48.

Subsequently, operation block 52 becomes active. In operation block 52, the digital camera stores the digital image in the new memory file.

From the foregoing, it can be seen that there has been brought to the art a new and improved digital image identification system 10. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims:

What is claimed is:

1. A method for cataloging an image created by a digital camera, the method comprising the steps of:
manually inputting a character sequence into an input device for the digital camera;
creating a memory file on the digital camera subject to identification by said character sequence;
assigning the image to said memory file; and
storing the image in said file.

2. The method as recited in claim 1 wherein said step of manually inputting includes the step of reading a character sequence from a bar code.

3. The method as recited in claim 1 wherein the step of assigning includes the step of transmitting said file to a remote server.

4. The method as recited in claim 1 further comprising the step of manually advancing said character sequence coinciding with said image.

5. A system for cataloging a digital image created by a digital camera, the system comprising:
a character string;
a character input device subject to receive said character string; and
a memory file on the digital camera subject to identification by said character string, said memory file further subject to electronically store the digital image.

6. The system as recited in claim 5 wherein said character input device is independent of the digital camera.

7. The system as recited in claim 5 wherein said character input device is a keypad.

8. The system as recited in claim 5 wherein said character input device is a bar code reader.

9. The system as recited in claim 5 wherein said memory file contains multiple digital images.

10. The system as recited in claim 5 further comprising a switch which advances said character string within said memory file.

11. The system as recited in claim 5 further comprising a second data transfer link which connects the digital camera to a remote server.

12. A system for cataloging a digital image created by a digital camera, the system comprising:
a character string;
a character input device subject to receive said character string;
a memory file on the digital camera subject to identification by said character string, said memory file further subject to electronically store the digital image;
a switch which advances a sequential indicator for said digital image within said memory file; and
a remote server subject to receive said memory file.

13. The system as recited in claim 12
wherein said character input device is independent of the digital camera.

14. The system as recited in claim 12
wherein said character input device is a keypad.

15. The system as recited in claim 12 wherein said character input device is a bar code reader.

16. The system as recited in claim 12 wherein said memory file contains multiple digital images.
